(19) United States
(12) Patent Application Publication
(10) Pub. No.: US 2015/0165323 A1
(43) Pub. Date: Jun. 18, 2015

(54) ANALOG UNDO FOR REVERSING VIRTUAL WORLD EDITS

(71) Applicant: MICROSOFT CORPORATION, Redmond, WA (US)

(72) Inventors: Robert Jason Major, Redmond, WA (US); Saxs Persson, Redmond, WA (US); Bradley Rebh, Bothell, WA (US); Lee Steg, Kirkland, WA (US)

(73) Assignee: MICROSOFT CORPORATION, Redmond, WA (US)

(21) Appl. No.: 14/109,818

(22) Filed: Dec. 17, 2013

(51) Int. Cl. A63F 13/52; A63F 13/63

(52) U.S. Cl. CPC A63F 13/52; A63F 13/63

(57) ABSTRACT

Systems and methods for editing a virtual world are described. The virtual world may comprise a gameworld associated with a video game that may be edited using a computer graphics editing tool integrated with a video game development environment. In some embodiments, a video game development environment may track a first set of edits made to a gameworld. Each edit of the first set of edits may correspond with an editing time. The video game development environment may detect an analog undo operation corresponding with a first editing time of a previously made edit to the gameworld and determine a gameworld state of the gameworld at the first editing time. The video game development environment may restore the gameworld to the gameworld state at the first editing time and display the gameworld based on a camera position and a camera orientation previously used at the first editing time.

### BACKGROUND

Video game development may refer to the software development process by which a video game may be produced. A video game may comprise an electronic game that involves human interaction by a game player of the video game for controlling video game objects, such as controlling the movement of a game-related character. The video game may be displayed to the game player via a display device, such as a television screen or computer monitor. The display device may display images corresponding with a gameworld or virtual environment associated with the video game. Various computing devices may be used for playing a video game, generating game-related images associated with the video game, and controlling gameplay interactions with the video game. For example, a video game may be played using a personal computer, handheld computing device, mobile device, or dedicated video game console.

### SUMMARY

Technology is described for generating and editing a virtual world. The virtual world may comprise a three-dimensional gameworld associated with a video game that may be edited using a computer graphics editing tool integrated with a video game development environment. In some embodiments, a video game development environment may track a first set of edits made to a gameworld associated with a video game. Each edit of the first set of edits may correspond with an editing time. The video game development environment may detect an analog undo operation corresponding with a first editing time of a previously made edit to the gameworld and determine a gameworld state of the gameworld at the first editing time. In some cases, the gameworld state may be determined by undoing each editing operation associated with a subset of the first set of edits that occurred subsequent to the first editing time. The video game development environment may restore the gameworld to the gameworld state at the first editing time and display the gameworld based on a camera position and a camera orientation previously used at the first editing time.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one embodiment of a networked computing environment.

FIG. 2 depicts one embodiment of a mobile device that may be used for providing a video game development environment for creating a video game.

FIG. 3 depicts one embodiment of a computing system for performing gesture recognition.

FIG. 4 depicts one embodiment of computing system including a capture device and computing environment.

FIG. 5A depicts one embodiment of a video game development environment in which a game developer may select a topography associated with a gameworld.

FIG. 5B depicts one embodiment of a video game development environment in which a game developer may sculpt portions of a gameworld.

FIG. 5C depicts one embodiment of a videogame development environment in which a game developer may apply a three-dimensional voxel material to portions of a gameworld.

FIG. 5D depicts one embodiment of a videogame development environment in which a game developer may select a protagonist.

FIG. 5E depicts one embodiment of a videogame development environment in which a story seed may be selected.

FIG. 5F depicts one embodiment of a videogame development environment in which game development decisions may be made during a gameplay sequence provided to a game developer during game development.

FIG. 6A depicts one embodiment of a video game development environment including an analog rewind slider for undoing editing operations previously performed to a gameworld.

FIG. 6B is a flowchart describing one embodiment of a method for editing and generating a virtual world.

FIG. 6C is a flowchart describing an alternative embodiment of a method for editing and generating a virtual world.

FIG. 7 is a block diagram of one embodiment of a mobile device.

FIG. 8 is a block diagram of an embodiment of a computing system environment.

### DETAILED DESCRIPTION

Technology is described for generating and editing a virtual world or a computer-generated virtual environment. The virtual world may comprise a three-dimensional gameworld associated with a video game. The virtual world may be generated or edited using a computer graphics editing tool integrated with a video game development environment. In some embodiments, a video game development environment may track (or record) a first set of edits made to a gameworld associated with a video game. Each edit of the first set of edits may correspond with an editing time (e.g., each edit may be linked to a time stamp). The video game development environment may detect an analog undo operation corresponding with a first editing time of a previously made edit to the gameworld and determine a gameworld state of the gameworld at the first editing time. In some cases, the gameworld state may be determined by undoing each editing operation associated with a subset of the first set of edits that occurred subsequent to the first editing time. The video game development environment may restore the gameworld to the gameworld state at the first editing time and display the gameworld based on a camera position and a camera orientation previously used at the first editing time. In one example, the gameworld may be displayed using the same camera position and the same camera orientation that was used when the previously made edit to the gameworld was made at the first editing time.

In some embodiments, editing operations performed using a computer graphics editing tool or a video game development environment may be recorded and time stamped. In one example, the editing operations may be recorded at periodic time intervals, such as every second or 30 times per second. Each editing operation may correspond with a particular object being edited (e.g., an object representing a protagonist of a video game) and the edit made to the particular object. Along with recording the editing operations performed and corresponding editing times, additional editing information may also be recorded corresponding with a camera position and a camera orientation associated with each edit made. The camera position and camera orientation may be used to determine a point of view used by an end user of a computer graphics editing tool when making a particular edit. The additional editing information may also include an editing mode (e.g., a sculpting mode, a painting mode, or an object editing mode) and an editing tool selection (e.g., a paintbrush tool or a select tool) associated with each edit made. The addition editing information may also include a size (e.g., a cursor size or a brush size) and a position associated with an editing tool used for making a particular edit.

In one embodiment, a rewind slider may be displayed for facilitating analog undo operations. The rewind slider may be controlled using various end user input, such as end user input from a keyboard, mouse, game controller, gesture-based interface, and/or a touch-based interface. The rewind slider may correspond with a touchscreen interface that allows an end user of a computer graphics editing tool to undo or reverse editing operations performed by the end user. In some cases, the end user may be able to undo editing operations in both a discrete manner (e.g., corresponding with discrete times at the beginning or end of an editing operation) and an analog manner (e.g., corresponding with intermediate times between the beginning and end of an editing operation). In one example, as the end user drags their finger along the rewind slider, editing operations performed on a gameworld may be partially reversed to a previous point in time in order to place the gameworld into a previous gameworld state. For example, a virtual ball fully painted using a paintbrush editing tool may be restored to a point in time when the virtual ball was only partially painted. In some cases, the rewind slider (or analog scrollbar) may represent a timeline associated with editing operations performed by the end user. After the end user has reversed editing operations previously performed by the end user, the end user may resume making edits to the gameworld from the restored gameworld state.

In some embodiments, a video game development environment may track both a first set of edits made to a gameworld associated with a video game and track a second set of edits corresponding with a plurality of game story options associated with the video game. An undo operation may comprise a sequence of inverse editing operations that undo or reverse editing operations performed to a virtual world subsequent to a particular point in time. An undo operation may be used to restore a virtual world to a state prior to the execution of various editing operations performed to the virtual world. A redo operation may comprise a sequence of editing operations that were previously performed to a virtual world prior to a particular point in time. In some cases, undo operations and/or redo operations may be performed on a first set of edits made to a gameworld associated with the videogame independently from the a second set of edits corresponding with a plurality of game story options associated with the video game. In one example, a game developer using a video game development environment may perform an analog undo operation to restore a gameworld to a previous gameworld state associated with a first time and then perform editing operations on the restored gameworld without impacting or altering the plurality of game story options made by the game developer subsequent to the first time.

In some embodiments, editing operations performed using a computer graphics editing tool or a video game development environment may be recorded and time stamped at periodic time intervals. In one example, editing operations performed on a gameworld may be tracked 30 times per second. Editing operations may also be tracked at a first frequency (e.g., at 30 times per second) during a first time period and then tracked at a second frequency different from the first frequency (e.g., every three seconds) during a second time period. Adjusting the sampling rate for recording changes to a gameworld over time (e.g., due to a rate of edits made by a game developer) may allow for more efficient use of memory resources. In one example, editing operations may be tracked at a first frequency during a first editing mode (e.g., during a painting mode) and then tracked at a second frequency during a second editing mode (e.g., during a terrain sculpting mode). In some cases, an edit tracking frequency for recording editing operations may be adjusted over time based on a rate of editing changes made by a game developer or other person making edits to a gameworld over time (e.g., based on an average rate of editing changes during a particular time period).

One issue involving the development of a video game by a game developer is that the time to create and edit a virtual world associated with the video game (e.g., a gameworld) may be significant. For example, the time to create various gameworld topographies, gameworld objects, game-related characters, and game-related animations may provide significant barriers to fully developing a gameworld for the video game. Thus, there is a need for providing a video game development environment that enables a game developer to quickly and easily generate and edit a gameworld.

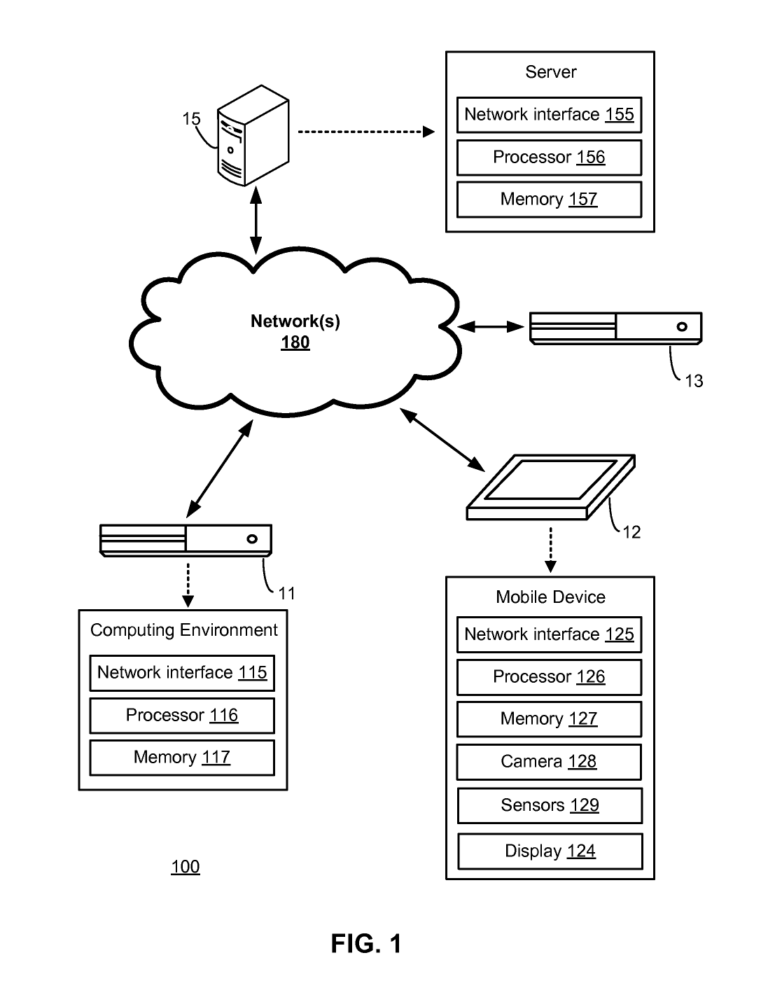

FIG. 1 is a block diagram of one embodiment of a networked computing environment 100 in which the disclosed technology may be practiced. Networked computing environment 100 includes a plurality of computing devices interconnected through one or more networks 180. The one or more networks 180 allow a particular computing device to connect to and communicate with another computing device. The depicted computing devices include computing environment 11, computing environment 13, mobile device 12, and server 15. The computing environment 11 may comprise a gaming console for playing video games. In some embodiments, the plurality of computing devices may include other computing devices not shown. In some embodiments, the plurality of computing devices may include more than or less than the number of computing devices shown in FIG. 1. The one or more networks 180 may include a secure network such as an enterprise private network, an unsecure network such as a wireless open network, a local area network (LAN), a wide area network (WAN), and the Internet. Each network of the one or more networks 180 may include hubs, bridges, routers, switches, and wired transmission media such as a wired network or direct-wired connection.

One embodiment of computing environment 11 includes a network interface 115, processor 116, and memory 117, all in communication with each other. Network interface 115 allows computing environment 11 to connect to one or more networks 180. Network interface 115 may include a wireless network interface, a modem, and/or a wired network interface. Processor 116 allows computing environment 11 to execute computer readable instructions stored in memory 117 in order to perform processes discussed herein.

In some embodiments, the computing environment 11 may include one or more CPUs and/or one or more GPUs. In some cases, the computing environment 11 may integrate CPU and GPU functionality on a single chip. In some cases, the single chip may integrate general processor execution with computer graphics processing (e.g., 3D geometry processing) and other GPU functions including GPGPU computations. The computing environment 11 may also include one or more FPGAs for accelerating graphics processing or performing other specialized processing tasks. In one embodiment, the computing environment 11 may include a CPU and a GPU in communication with a shared RAM. The shared RAM may comprise a DRAM (e.g., a DDR3 SDRAM).

Server 15 may allow a client or computing device to download information (e.g., text, audio, image, and video files) from the server or to perform a search query related to particular information stored on the server. In one example, a computing device may download purchased downloadable content and/or user generated content from server 15 for use with a video game development environment running on the computing device. In general, a “server” may include a hardware device that acts as the host in a client-server relationship or a software process that shares a resource with or performs work for one or more clients. Communication between computing devices in a client-server relationship may be initiated by a client sending a request to the server asking for access to a particular resource or for particular work to be performed. The server may subsequently perform the actions requested and send a response back to the client.

One embodiment of server 15 includes a network interface 155, processor 156, and memory 157, all in communication with each other. Network interface 155 allows server 15 to connect to one or more networks 180. Network interface 155 may include a wireless network interface, a modem, and/or a wired network interface. Processor 156 allows server 15 to execute computer readable instructions stored in memory 157 in order to perform processes discussed herein.

One embodiment of mobile device 12 includes a network interface 125, processor 126, memory 127, camera 128, sensors 129, and display 124, all in communication with each other. Network interface 125 allows mobile device 12 to connect to one or more networks 180. Network interface 125 may include a wireless network interface, a modem, and/or a wired network interface. Processor 126 allows mobile device 12 to execute computer readable instructions stored in memory 127 in order to perform processes discussed herein. Camera 128 may capture color images and/or depth images of an environment. The mobile device 12 may include outward facing cameras that capture images of the environment and inward facing cameras that capture images of the end user of the mobile device. Sensors 129 may generate motion and/or orientation information associated with mobile device 12. In some cases, sensors 129 may comprise an inertial measurement unit (IMU). Display 124 may display digital images and/or videos. Display 124 may comprise an LED or OLED display. The mobile device 12 may comprise a tablet computer.

In some embodiments, various components of a computing device including a network interface, processor, and memory may be integrated on a single chip substrate. In one example, the components may be integrated as a system on a chip (SOC). In other embodiments, the components may be integrated within a single package.

In some embodiments, a computing device may provide a natural user interface (NUI) to an end user of the computing device by employing cameras, sensors, and gesture recognition software. With a natural user interface, a person's body parts and movements may be detected, interpreted, and used to control various aspects of a computing application running on the computing device. In one example, a computing device utilizing a natural user interface may infer the intent of a person interacting with the computing device (e.g., that the end user has performed a particular gesture in order to control the computing device).

Networked computing environment 100 may provide a cloud computing environment for one or more computing devices. Cloud computing refers to Internet-based computing, wherein shared resources, software, and/or information are provided to one or more computing devices on-demand via the Internet (or other global network). The term “cloud” is used as a metaphor for the Internet, based on the cloud drawings used in computer networking diagrams to depict the Internet as an abstraction of the underlying infrastructure it represents.

In one embodiment, a video game development program running on a computing environment, such as computing environment 11, may provide a video game development environment to a game developer that allows the game developer to customize a gameworld environment associated with a video game by virtually sculpting (or shaping) and painting the gameworld and positioning and painting game-related objects within the gameworld (e.g., houses and rocks). The video game development environment may combine game development activities with gameplay. In one example, the video game development environment may prompt a game developer using the computing environment to specify various video game design options such as whether the video game uses a first-person perspective view (e.g., a first-person shooter video game) and/or a third-person perspective view (e.g., a third-person action adventure video game). The video game development environment may then prompt the game developer to select a game story related option (e.g., whether the video game will involve saving a princess or discovering a treasure). Once the game story related option has been selected, the video game development environment may then generate a gameplay sequence (e.g., providing five minutes of gameplay within a gameworld) in which the game developer may control a game-related character (e.g., the game's protagonist) within the gameworld. The game developer may control the game-related character during the gameplay sequence using touch-sensitive input controls or gesture recognition based input controls.

During the gameplay sequence, the game-related character may satisfy a particular gameplay objective that may allow particular game design options to be unlocked or to become available to the game developer. In some cases, some of the video game design options may be locked or otherwise made not accessible to the game developer if the game developer fails to satisfy the particular gameplay objective during the gameplay sequence. In one example, if the particular gameplay objective is not satisfied, then the game developer may be asked to choose what kinds of monsters should be included near a cave entrance within the gameworld. However, if the particular gameplay objective is satisfied, then the game developer may be asked to identify the kinds of monsters to be included near a cave entrance within the gameworld and to provide specific locations for individual monsters within the gameworld. The gameworld may comprise a computer-generated virtual world in which game-related objects associated with the video game (e.g., game-related characters) may be controlled or moved by a game player.

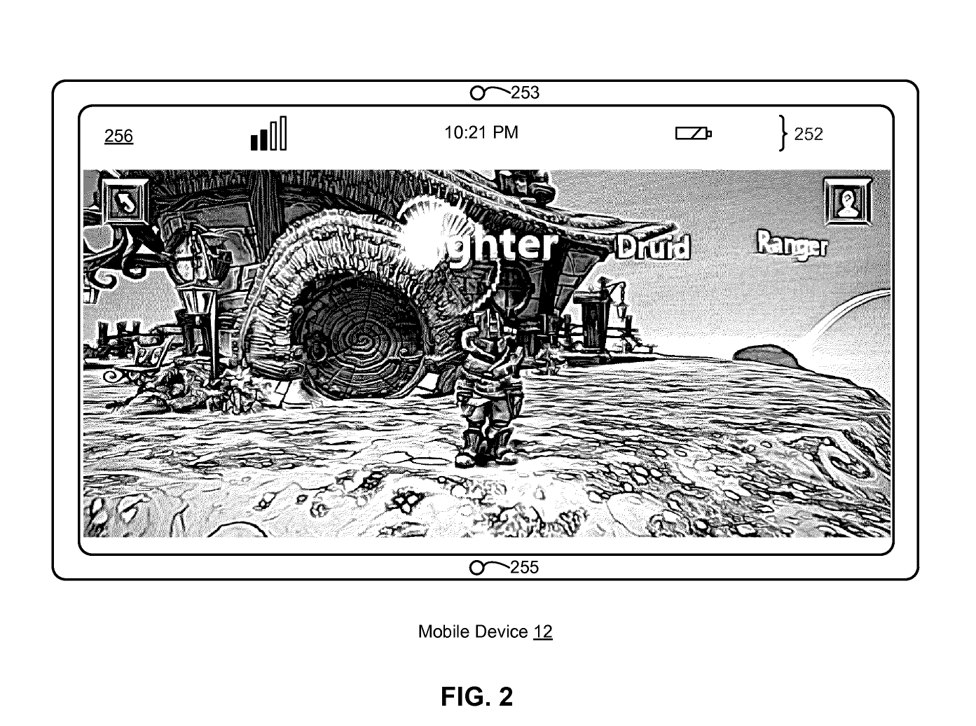

FIG. 2 depicts one embodiment of a mobile device 12 that may be used for providing a video game development environment for creating a video game. The mobile device 12 may comprise a tablet computer with a touch-screen interface. In one embodiment, the video game development environment may run locally on the mobile device 12. In other embodiments, the mobile device 12 may facilitate control of a video game development environment running on a computing environment, such as computing environment 11 in FIG. 1, or running on a server, such as server 15 in FIG. 1, via a wireless network connection. As depicted, mobile device 12 includes a touchscreen display 256, a microphone 255, and a front-facing camera 253. The touchscreen display 256 may include an LCD display for presenting a user interface to an end user of the mobile device. The touchscreen display 256 may include a status area 252 which provides information regarding signal strength, time, and battery life associated with the mobile device. In some embodiments, the mobile device may determine a particular location of the mobile device (e.g., via GPS coordinates). The microphone 255 may capture audio associated with the end user (e.g., the end user's voice) for determining the identity of the end user and for handling voice commands issued by the end user. The front-facing camera 253 may be used to capture images of the end user for determining the identity of the end user and for handling gesture commands issued by the end user. In one embodiment, an end user of the mobile device 12 may generate a video game by controlling a video game development environment viewed on the mobile device using touch gestures and/or voice commands.

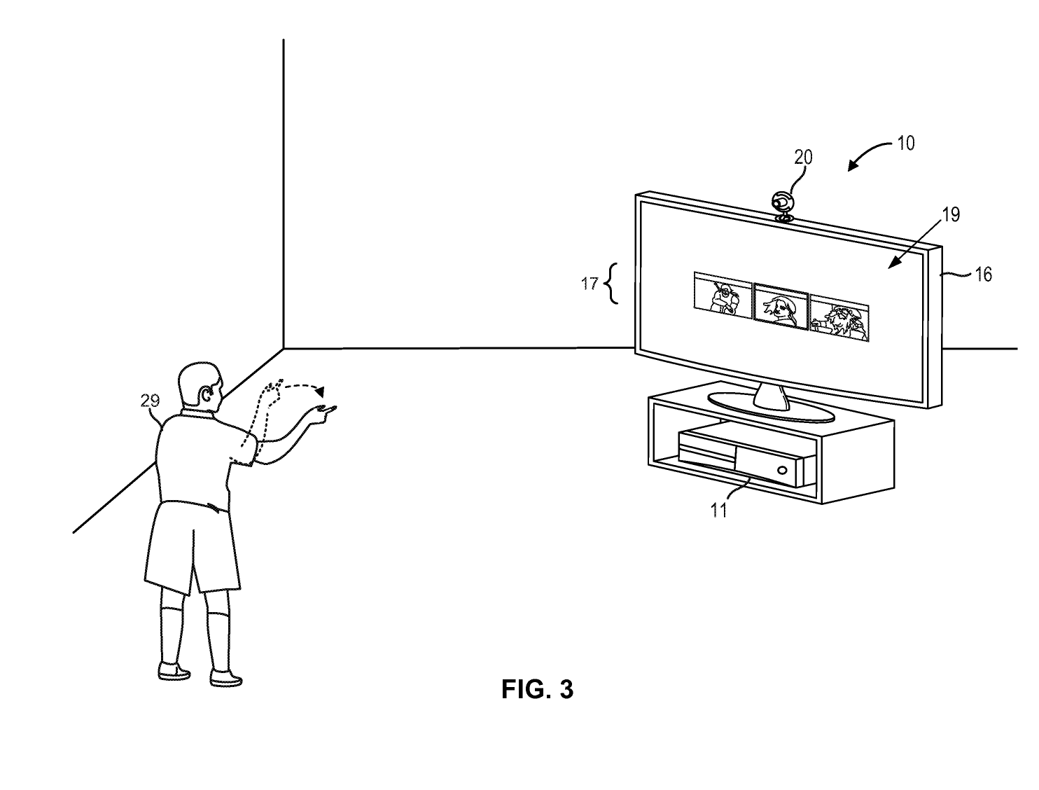

FIG. 3 depicts one embodiment of a computing system 10 that utilizes depth sensing for performing object and/or gesture recognition. The computing system 10 may include a computing environment 11, a capture device 20, and a display 16, all in communication with each other. Computing environment 11 may include one or more processors. Capture device 20 may include one or more color or depth sensing cameras that may be used to visually monitor one or more targets including humans and one or more other real objects within a particular environment. Capture device 20 may also include a microphone. In one example, capture device 20 may include a depth sensing camera and a microphone and computing environment 11 may comprise a gaming console.

In some embodiments, the capture device 20 may include an active illumination depth camera, which may use a variety of techniques in order to generate a depth map of an environment or to otherwise obtain depth information associated the environment including the distances to objects within the environment from a particular reference point. The techniques for generating depth information may include structured light illumination techniques and time of flight (TOF) techniques.

As depicted in FIG. 3, a user interface 19 is displayed on display 16 such that an end user 29 of the computing system 10 may control a computing application running on computing environment 11. The user interface 19 includes images 17 representing user selectable icons. In one embodiment, computing system 10 utilizes one or more depth maps in order to detect a particular gesture being performed by end user 29. In response to detecting the particular gesture, the computing system 10 may control the computing application, provide input to the computing application, or execute a new computing application. In one example, the particular gesture may be used to identify a selection of one of the user selectable icons associated with one of three different story seeds for a video game. In one embodiment, an end user of the computing system 10 may generate a video game by controlling a video game development environment viewed on the display 16 using gestures.

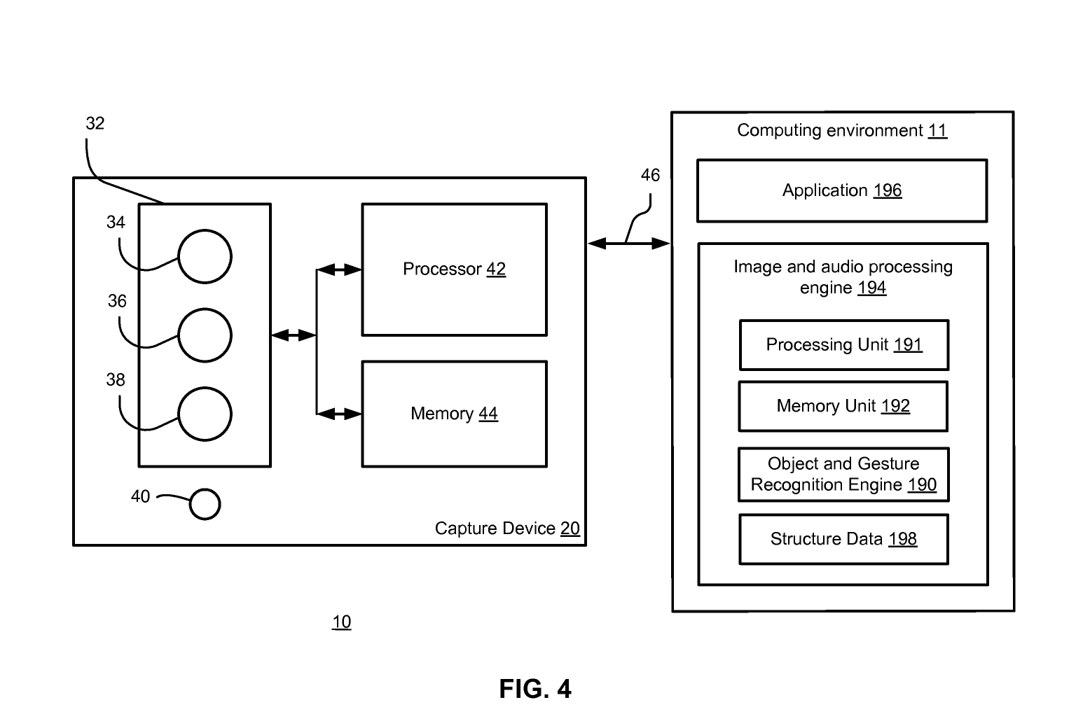

FIG. 4 depicts one embodiment of computing system 10 including a capture device 20 and computing environment 11. In some embodiments, capture device 20 and computing environment 11 may be integrated within a single computing device. The single computing device may comprise a mobile device, such as mobile device 12 in FIG. 1.

In one embodiment, the capture device 20 may include one or more image sensors for capturing images and videos. An image sensor may comprise a CCD image sensor or a CMOS image sensor. In some embodiments, capture device 20 may include an IR CMOS image sensor. The capture device 20 may also include a depth sensor (or depth sensing camera) configured to capture video with depth information including a depth image that may include depth values via any suitable technique including, for example, time-of-flight, structured light, stereo image, or the like.

The capture device 20 may include an image camera component 32. In one embodiment, the image camera component 32 may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the image camera component 32.

The image camera component 32 may include an IR light component 34, a three-dimensional (3-D) camera 36, and an RGB camera 38 that may be used to capture the depth image of a capture area. For example, in time-of-flight analysis, the IR light component 34 of the capture device 20 may emit an infrared light onto the capture area and may then use sensors to detect the backscattered light from the surface of one or more objects in the capture area using, for example, the 3-D camera 36 and/or the RGB camera 38. In some embodiments, pulsed infrared light may be used such that the time between an outgoing light pulse and a corresponding incoming light pulse may be measured and used to determine a physical distance from the capture device 20 to a particular location on the one or more objects in the capture area. Additionally, the phase of the outgoing light wave may be compared to the phase of the incoming light wave to determine a phase shift. The phase shift may then be used to determine a physical distance from the capture device to a particular location associated with the one or more objects.

In another example, the capture device 20 may use structured light to capture depth information. In such an analysis, patterned light (i.e., light displayed as a known pattern such as grid pattern or a stripe pattern) may be projected onto the capture area via, for example, the IR light component 34. Upon striking the surface of one or more objects (or targets) in the capture area, the pattern may become deformed in response. Such a deformation of the pattern may be captured by, for example, the 3-D camera 36 and/or the RGB camera 38 and analyzed to determine a physical distance from the capture device to a particular location on the one or more objects. Capture device 20 may include optics for producing collimated light. In some embodiments, a laser projector may be used to create a structured light pattern. The light projector may include a laser, laser diode, and/or LED.

In some embodiments, two or more different cameras may be incorporated into an integrated capture device. For example, a depth camera and a video camera (e.g., an RGB video camera) may be incorporated into a common capture device. In some embodiments, two or more separate capture devices of the same or differing types may be cooperatively used. For example, a depth camera and a separate video camera may be used, two video cameras may be used, two depth cameras may be used, two RGB cameras may be used, or any combination and number of cameras may be used. In one embodiment, the capture device 20 may include two or more physically separated cameras that may view a capture area from different angles to obtain visual stereo data that may be resolved to generate depth information. Depth may also be determined by capturing images using a plurality of detectors that may be monochromatic, infrared, RGB, or any other type of detector and performing a parallax calculation. Other types of depth image sensors can also be used to create a depth image.

As depicted, capture device 20 may also include one or more microphones 40. Each of the one or more microphones 40 may include a transducer or sensor that may receive and convert sound into an electrical signal. The one or more microphones may comprise a microphone array in which the one or more microphones may be arranged in a predetermined layout.

The capture device 20 may include a processor 42 that may be in operative communication with the image camera component 32. The processor may include a standardized processor, a specialized processor, a microprocessor, or the like. The processor 42 may execute instructions that may include instructions for storing filters or profiles, receiving and analyzing images, determining whether a particular situation has occurred, or any other suitable instructions. It is to be understood that at least some image analysis and/or target analysis and tracking operations may be executed by processors contained within one or more capture devices such as capture device 20.

The capture device 20 may include a memory 44 that may store the instructions that may be executed by the processor 42, images or frames of images captured by the 3-D camera or RGB camera, filters or profiles, or any other suitable information, images, or the like. In one example, the memory 44 may include random access memory (RAM), read only memory (ROM), cache, Flash memory, a hard disk, or any other suitable storage component. As depicted, the memory 44 may be a separate component in communication with the image capture component 32 and the processor 42. In another embodiment, the memory 44 may be integrated into the processor 42 and/or the image capture component 32. In other embodiments, some or all of the components 32, 34, 36, 38, 40, 42 and 44 of the capture device 20 may be housed in a single housing.

The capture device 20 may be in communication with the computing environment 11 via a communication link 46. The communication link 46 may be a wired connection including, for example, a USB connection, a FireWire connection, an Ethernet cable connection, or the like and/or a wireless connection such as a wireless 802.11b, g, a, or n connection. The computing environment 12 may provide a clock to the capture device 20 that may be used to determine when to capture, for example, a scene via the communication link 46. In one embodiment, the capture device 20 may provide the images captured by, for example, the 3D camera 36 and/or the RGB camera 38 to the computing environment 11 via the communication link 46.

As depicted in FIG. 4, computing environment 11 may include an image and audio processing engine 194 in communication with application 196. Application 196 may comprise an operating system application or other computing application such as a video game development program. Image and audio processing engine 194 includes object and gesture recognition engine 190, structure data 198, processing unit 191, and memory unit 192, all in communication with each other. Image and audio processing engine 194 processes video, image, and audio data received from capture device 20. To assist in the detection and/or tracking of objects, image and audio processing engine 194 may utilize structure data 198 and object and gesture recognition engine 190.

Processing unit 191 may include one or more processors for executing object, facial, and/or voice recognition algorithms. In one embodiment, image and audio processing engine 194 may apply object recognition and facial recognition techniques to image or video data. For example, object recognition may be used to detect particular objects (e.g., soccer balls, cars, or landmarks) and facial recognition may be used to detect the face of a particular person. Image and audio processing engine 194 may apply audio and voice recognition techniques to audio data. For example, audio recognition may be used to detect a particular sound. The particular faces, voices, sounds, and objects to be detected may be stored in one or more memories contained in memory unit 192. Processing unit 191 may execute computer readable instructions stored in memory unit 192 in order to perform processes discussed herein.

The image and audio processing engine 194 may utilize structure data 198 while performing object recognition. Structure data 198 may include structural information about targets and/or objects to be tracked. For example, a skeletal model of a human may be stored to help recognize body parts. In another example, structure data 198 may include structural information regarding one or more inanimate objects in order to help recognize the one or more inanimate objects.

The image and audio processing engine 194 may also utilize object and gesture recognition engine 190 while performing gesture recognition. In one example, object and gesture recognition engine 190 may include a collection of gesture filters, each comprising information concerning a gesture that may be performed by a skeletal model. The object and gesture recognition engine 190 may compare the data captured by capture device 20 in the form of the skeletal model and movements associated with it to the gesture filters in a gesture library to identify when a user (as represented by the skeletal model) has performed one or more gestures. In one example, image and audio processing engine 194 may use the object and gesture recognition engine 190 to help interpret movements of a skeletal model and to detect the performance of a particular gesture.

More information about detecting objects and performing gesture recognition can be found in U.S. patent application Ser. No. 12/641,788, “Motion Detection Using Depth Images,” filed on Dec. 18, 2009; and U.S. patent application Ser. No. 12/475,308, “Device for Identifying and Tracking Multiple Humans over Time,” both of which are incorporated herein by reference in their entirety. More information about object and gesture recognition engine 190 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool,” filed on May 29, 2009, both of which are incorporated by reference herein in their entirety.

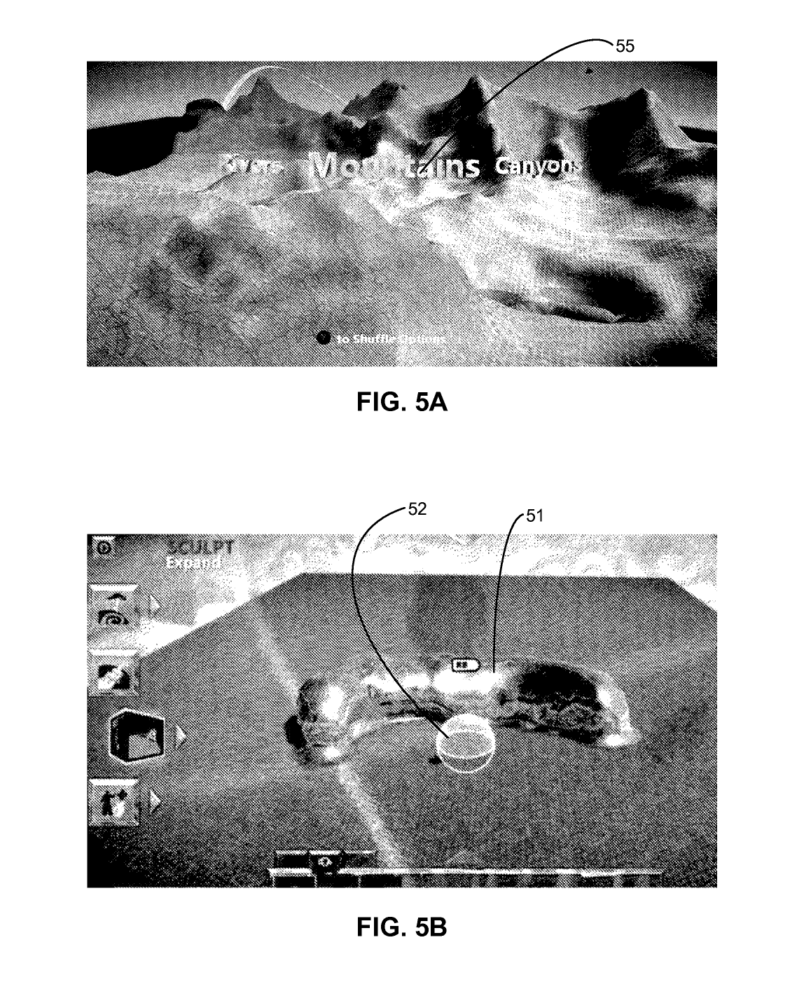

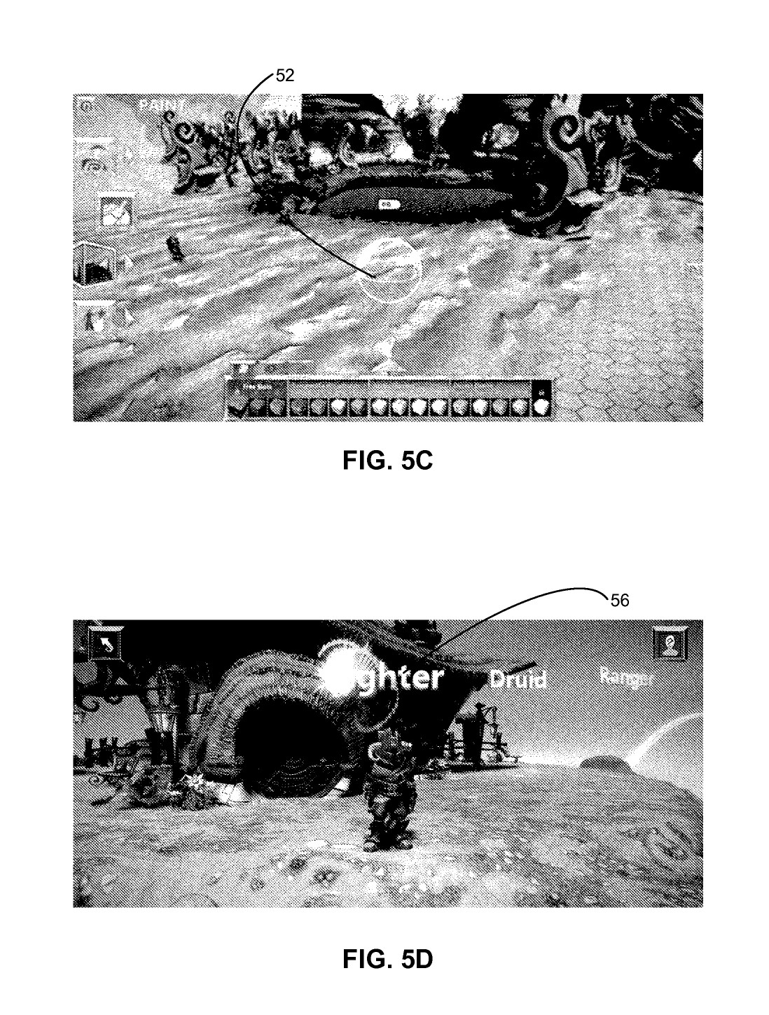

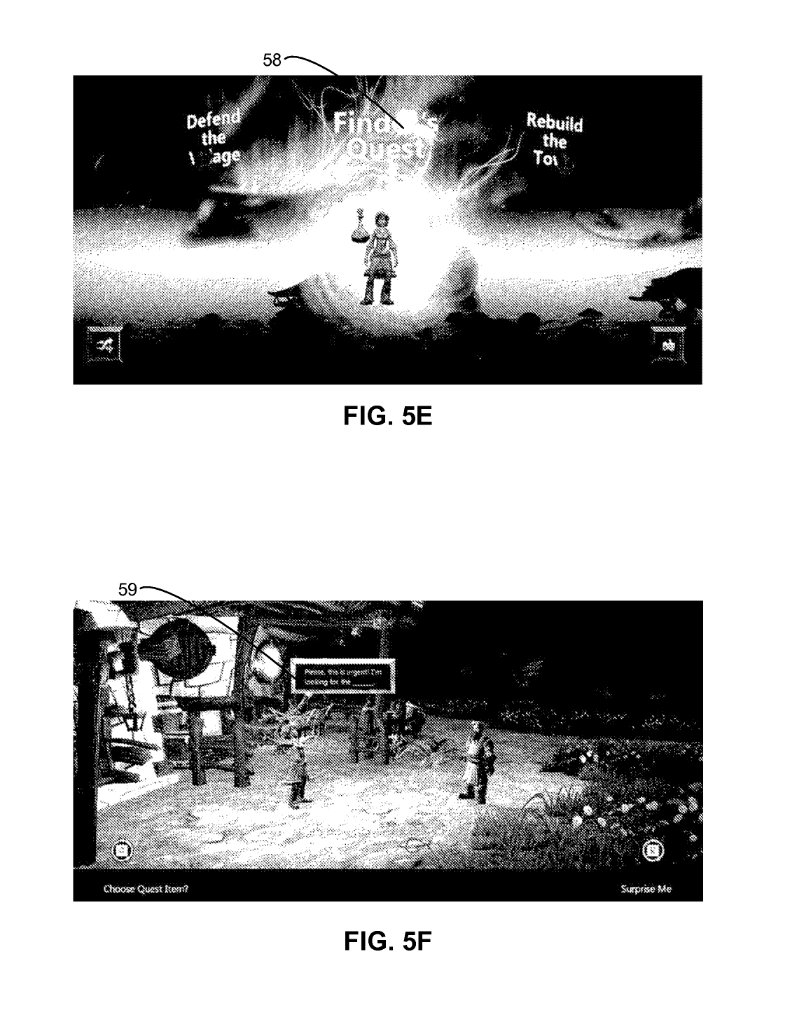

FIGS. 5A-5F depict various embodiments of a video game development environment.

FIG. 5A depicts one embodiment of a video game development environment in which a game developer may select a topography associated with a gameworld. In one example, the game developer may be given choices 55 regarding the terrain and/or appearance of the gameworld. In one embodiment, the choices 55 may correspond with three predesigned gameworld environments. The game developer may select a type of terrain such as rivers, mountains, and canyons. Based on the terrain selection, the game developer may then select a biome for the gameworld, such as woodlands, desert, or arctic. A biome may comprise an environment in which similar climatic conditions exist. The game developer may also select a time of day (e.g., day, night, or evening) to establish lighting conditions within the gameworld.

FIG. 5B depicts one embodiment of a video game development environment in which a game developer may sculpt (or shape) portions of a gameworld. The game developer may use a pointer or selection region for selecting a region within the gameworld to be sculpted. The pointer or selection region may be controlled by the game developer using a touchscreen interface or by performing gestures or voice commands. The pointer or selection region may also be controlled by the game developer using a game controller. As depicted, a selection region 52 in the shape of a sphere may be used to sculpt a virtual hill 51 within the gameworld. The game developer may sculpt the virtual hill 51 from a flat gameworld or after portions of a gameworld have already been generated, for example, after a mountainous gameworld has been generated similar to that depicted in FIG. 5A.

Using the selection region 52, the game developer may modify the topography of a gameworld by pushing and/or pulling portions of the gameworld or digging through surfaces of the gameworld (e.g., drilling a hole in a mountain). The game developer may use selection tools to customize the topography of the gameworld and to add objects into the gameworld such as plants, animals, and inanimate objects, such as rocks. Each of the objects placed into the gameworld may be given a “brain” corresponding with programmed object behaviors, such as making a rock run away from a protagonist or fight the protagonist if the protagonist gets within a particular distance of the rock.

FIG. 5C depicts one embodiment of a videogame development environment in which a game developer may paint or color portions of a gameworld or apply a three-dimensional voxel material. As depicted, a selection region 52 may be used to color portions of the gameworld. In one example, a desert region that is originally generated using a yellow color may be painted a different color, such as purple. The game developer was also paint objects, such as rocks and/or NPCs that have been placed into the gameworld by the game developer or automatically placed by the videogame development environment based on previous video game design decision made by the game developer. The NPCs may comprise non-player controlled characters within the gameworld and may include animals, villagers, and hostile creatures. In some cases, a game developer may apply a texture or apply a three-dimensional voxel material to a portion of the gameworld (e.g., the game developer may cover a hill with a green grass texture).

FIG. 5D depicts one embodiment of a videogame development environment in which a game developer may select a protagonist. As depicted, the game developer may be given choices 56 regarding which leading game character or protagonist will be controlled by a game player of the video game. In one example, the protagonist may comprise a fighter, druid, or ranger. The protagonist may correspond with a hero of the video game. The selected protagonist may comprise a character that is controlled by the game developer during gameplay sequences provided to the game developer during development of the video game. The selected protagonist may comprise the character that is controlled by a game player when the video game developed by the game developer is generated and outputted for play by the game player.

In some embodiments, the gameplay sequences provided to a game developer during development of a video game may not be accessible or displayed to a game player of the video game (or to anyone once the video game has been created). In this case, after the video game has been generated, the animations and/or data for generating the gameplay sequences may not be part of the video game. In one example, code associated with gameplay sequences during video game development may not be part of the video game.

FIG. 5E depicts one embodiment of a videogame development environment in which a gameplay archetype or a story seed may be selected. A story seed may correspond with a framework for selecting a sequence of story related events associated with a video game. A particular sequence of story related events (e.g., decided by a game developer) may correspond with a video game plot for the video game. In one example, a story seed may be used to generate one or more game story options associated with story related decisions for creating the video game. In one example, if a story seed is related to a driving game, then a first set of the one or more game story options may be related to a point of view associated with the driving game (e.g., should the driving game use a behind-the-wheel first-person perspective or an outside-the-car third-person perspective), and a second set of the one or more game story options may depend upon a first option (e.g., the game story option related to a behind-the-wheel first-person perspective) of the first set of the one or more game story options and may be related to the primary objective of the driving game (e.g., whether the primary objective or goal of the driving game is to win a car race, escape from an antagonist pursuing the protagonist, or to drive to a particular location within a gameworld). In some cases, a third set of the one or more game story options may depend upon a second option of the one or more game story options and may be related to identification of the protagonist of the driving game.

In some embodiments, the story seed may correspond with a high-level game story selection associated with a root node of a decision tree and non-root nodes of the decision tree may correspond with one or more game story options. Once a selection of a subset of the game story options associated with a particular path between a root node of the tree and a leaf node of the tree has been determined by the game developer, then a video game may be generated corresponding with the particular path. Each of the paths from the root node to a leaf node of the decision tree may correspond with different video games.

In some embodiments, the story seed may correspond with one or more game story options that must be determined by the game developer prior to generating a video game associated with the story seed. The one or more game story options may include selection of a protagonist (e.g., the hero of the video game), selection of an antagonist (e.g., the enemy of the hero), and selection of a primary objective associated with the story seed (e.g., saving a princess by defeating the antagonist). The primary objective may comprise the ultimate game-related goal to be accomplished by the protagonist. As depicted, a game developer may be given choices 58 regarding the story seed associated with the video game. In one example, the game developer may select between one of three story seeds including Finder's Quest, which comprises a mission where the protagonist must find a hidden object within the gameworld and return the hidden object to a particular location within the gameworld.

Once the story seed has been selected by the game developer, then the game developer may be presented with options regarding a secondary game objective. Secondary game objectives may depend upon the selection of the selected story seed or depend on a previously selected game objective (e.g., defeating a particular boss or last stage enemy during a final battle within the video game). In one example, if the selected story seed is associated with finding a hidden object within a gameworld, then the secondary game objective may comprise discovering a tool or resource necessary for finding the hidden object, such as finding a boat to cross a river that must be overcome for finding the hidden object. In another example, if the selected story seed corresponds with having to defend a village from a monster, then the secondary game objective my comprise locating a particular weapon necessary to defeat the monster.

In some embodiments, questions regarding secondary (or dependent) game objectives may be presented to the game developer during one or more gameplay sequences. In one example, after a game developer has selected a story seed, a starting point within the gameworld in which a protagonist must start their journey, and an ending point for the video game (e.g., the last castle where the final boss fight will occur), a gameplay sequence may be displayed to the game developer in which the game developer may control the protagonist to encounter NPCs requesting game development decisions to be made. For example, during a gameplay sequence, the protagonist may encounter a villager asking the protagonist to decide which weapon is best to use against the last stage boss.

FIG. 5F depicts one embodiment of a videogame development environment in which game development decisions may be made during a gameplay sequence provided to a game developer during game development. The gameplay sequence allows the game developer to engage in gameplay within a game development environment. As depicted, a game developer may be given a choice 59 regarding a type of object to be found within the gameworld. The type of object to be found may correspond with a story seed previously selected by the game developer. In one example, the game developer may control the protagonist (or a character representation of the protagonist) during a gameplay sequence and come across an NPC (e.g., a villager) that interacts with the protagonist and asks a question regarding what type of hidden object should be found. The game developer may specify the object to be found by selecting an object from a list of predetermined objects to be found or by allowing the game development environment to randomly select an object and to automatically assign the object to be found (e.g., by selecting a “surprise me” option).

In some embodiment, during a gameplay sequence a side quest may be discovered by the game developer while moving the protagonist along one or more paths between the starting point and the ending point for the video game. A side quest may comprise an unexpected encounter during the gameplay sequence used for rewarding the game developer for engaging in gameplay. In one embodiment, a side quest may be generated when the game developer places the protagonist within a particular region of the gameworld during a gameplay sequence (e.g., takes a particular path or enters a dwelling within the gameworld environment). The side quest may provide additional gameplay in which the game developer may satisfy conditions that allow additional game development options to become available to the game developer (e.g., additional weapons choices may be unlocked and become available to the protagonist).

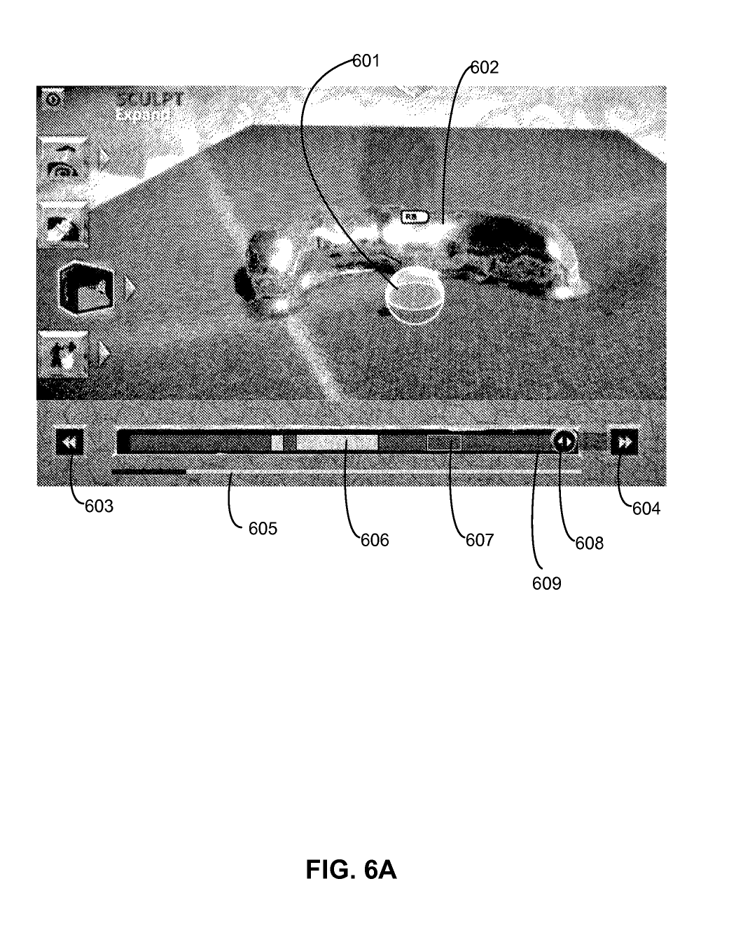

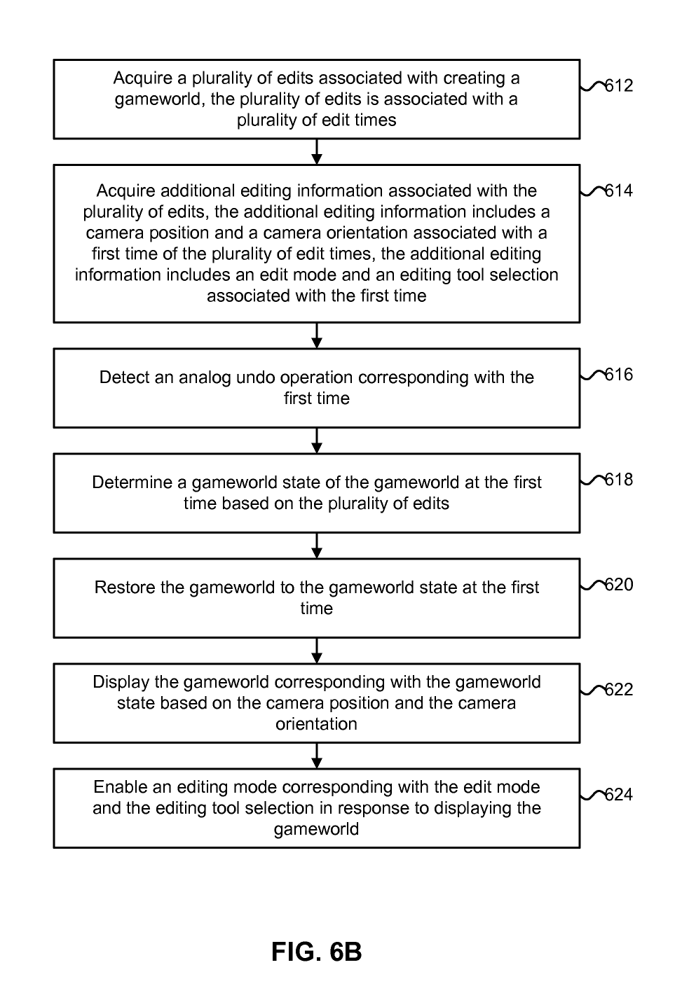

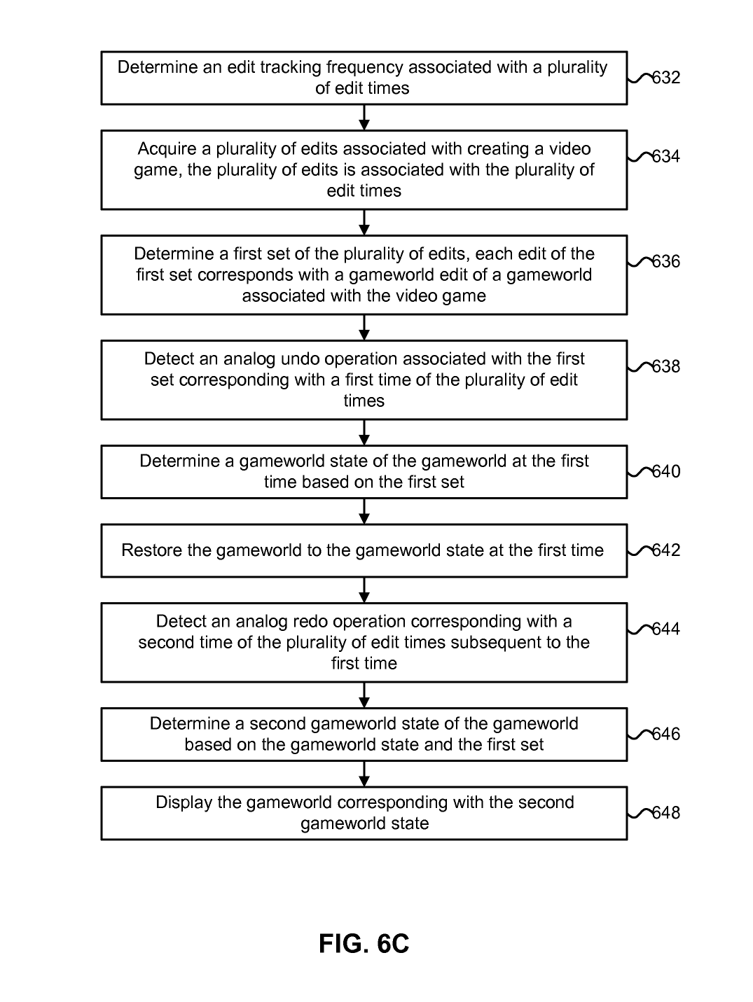

FIG. 6A depicts one embodiment of a video game development environment including an analog rewind slider 608 for undoing or rewinding (or rewinding and then fast forwarding) through editing operations previously performed to a gameworld. A game developer may use a pointer or selection region 601 to select a region or an object within the gameworld to be edited. The pointer or selection region may be controlled by the game developer using a touchscreen display, such as touchscreen display 256 in FIG. 2. In one example, the selection region 601 may be used to edit the gameworld (e.g., to shape or sculpt a virtual hill 602 within the gameworld). The topography of the gameworld may be modified or edited by pushing and/or pulling portions of the gameworld or digging through surfaces of the gameworld (e.g., drilling a hole in a mountain) using the selection region 601.

As depicted, an analog rewind slider 608 may allow a game developer to undo editing operations previously performed by the game developer. In one example, as the game developer drags the analog rewind slider 608 along an editing operations timeline, editing operations previously performed on the gameworld may be partially reversed to a previous point in time in order to place the gameworld into a previous gameworld state. As each editing operation may correspond with a point in time at which the editing operation was made (e.g., each editing operation may be recorded along with a corresponding time stamp), the game developer may rewind or undo editing operations previously performed such that the gameworld may be placed into a gameworld state associated with the previous point in time. Once the game developer has placed the gameworld into a previous gameworld state, the game developer may resume making edits to the gameworld from the restored gameworld state.

The game developer may select a point in time corresponding with a previous editing operation by either using the analog rewind slider 608 and/or using discrete buttons 603-604 corresponding with chapter markers, such as chapter marker 609, placed within a timeline of previous editing operations. In one example, the chapter markers may correspond with the beginning or end of a particular editing mode (e.g., a sculpting mode) and/or the beginning or end of editing operations performed to a particular object within the gameworld (e.g., editing operations performed to a house within the gameworld). In some cases, color coding may be used to identify different editing modes. For example, a first color 606 may be used to identify a first editing mode and a second color 607 may be used to identify a second editing mode. A rewind buffer indicator 605 may display an amount of memory available for recording editing operations.

FIG. 6B is a flowchart describing one embodiment of a method for editing and generating a virtual world, such as a gameworld. In one embodiment, the process of FIG. 6B may be performed by a gaming console or a computing environment, such as computing environment 11 in FIG. 1.

In step 612, a plurality of edits associated with creating or editing a gameworld is acquired. Each of the plurality of edits to the gameworld may be made by an end user of a computer graphics editing tool or a video game development environment. The gameworld may comprise a three-dimensional gameworld associated with a video game. The gameworld may be represented by a plurality of voxels arranged in a three-dimensional grid. Each voxel of the plurality of voxels may comprise a color value and an opacity value. The plurality of edits may be associated with a plurality of edit times. In one example, each edit of the plurality of edits may be time stamped based on a time at which the edit was made to the gameworld. Each edit time may correspond with an absolute time at which the edit was made (e.g., a date and a time of day) or a relative time at which the edit was made (e.g., relative to the times at which other edits were made).

In step 614, additional editing information associated with the plurality of edits is acquired. The additional editing information may include a camera position and a camera orientation associated with a first time of the plurality of edit times. The camera position and the camera orientation may be used to determine a point of view used by an end user of a computer graphics editing tool when making a particular edit at the first time. The additional editing information may include an edit mode and an editing tool selection associated with the first time. The edit mode may comprise a sculpting mode, a painting mode, or an object editing mode. The editing tool may comprise a paintbrush tool or an object selection tool. The addition editing information may also include a size and a position associated with an editing tool used for making a particular edit at the first time.

In step 616, an analog undo operation corresponding with the first time is detected. In one embodiment, the analog undo operation may be detected when an analog rewind slider, such as analog rewind slider 608 in FIG. 6A, is moved to correspond with a previous edit made to the gameworld. For example, an end user of a computer graphics editing tool may use their finger to drag the analog rewind slider using a touchscreen display, such as touchscreen display 256 in FIG. 2, along an editing operations timeline associated with editing operations previously performed on the gameworld.

In step 618, a gameworld state of the gameworld at the first time is determined based on the plurality of edits acquired in step 612. The gameworld state may be determined by undoing or reversing editing operations performed to the gameworld subsequent to the first time. In step 620, the gameworld is restored to the gameworld state at the first time. The gameworld may be restored to the gameworld state by performing a sequence of inverse editing operations that undo or reverse editing operations performed to a gameworld subsequent to the first time. In step 622, the gameworld corresponding with the gameworld state is displayed based on the camera position and the camera orientation. In one example, the gameworld may be displayed using the same camera position and the same camera orientation that was used when the previous edit was made to the gameworld at the first time. The gameworld may be displayed using a display, such as display 124 and FIG. 1. In step 624, an editing mode corresponding with the edit mode and the editing tool selection are enabled in response to displaying the gameworld. In one embodiment, an object being edited previously at the first time may be identified by highlighting the object.

FIG. 6C is a flowchart describing an alternative embodiment of a method for editing and generating a virtual world, such as a gameworld. In one embodiment, the process of FIG. 6C may be performed by a gaming console or a computing environment, such as computing environment 11 in FIG. 1.

In step 632, an edit tracking frequency associated with a plurality of edit times is determined. In one embodiment, the edit tracking frequency may be set at 30 times per second (i.e., edits may be tracked at 30 edits per second). The edit tracking frequency may be determined based on an editing mode used for modifying a gameworld (e.g., a sculpting mode). The edit tracking frequency may also be adjusted over time based on a rate of editing changes made by an end user of a video game development environment to a video game over time (e.g., based on an average rate of editing changes made during a particular time period).

In step 634, a plurality of edits associated with creating or editing a video game is acquired. The plurality of edits may be associated with the plurality of edit times determined in step 632. Each edit time of the plurality of edit times may correspond with an absolute time at which the edit was made (e.g., a date and a time of day) or a relative time at which the edit was made (e.g., relative to the times at which other edits were made). In step 636, a first set of the plurality of edits is determined. Each edit of the first set of the plurality of edits may correspond with a gameworld edit of a gameworld associated with the video game. In some embodiments, the plurality of edits may include a first set of edits made to a gameworld associated with a video game and a second set of edits corresponding with a plurality of game story options associated with the video game.

In step 638, an analog undo operation associated with the first set corresponding with a first time of the plurality of edit times is detected. In one embodiment, the analog undo operation may be detected when an analog rewind slider, such as analog rewind slider 608 in FIG. 6A, is moved to correspond with a previous edit made to the gameworld. For example, an end user of a computer graphics editing tool may use their finger to drag the analog rewind slider using a touchscreen display, such as touchscreen display 256 in FIG. 2, along an editing operations timeline associated with editing operations previously performed on the gameworld.

In step 640, a gameworld state of the gameworld at the first time is determined based on the first set. The gameworld state may be determined by undoing or reversing editing operations performed to the gameworld subsequent to the first time. In step 642, the gameworld is restored to the gameworld state at the first time. The gameworld may be restored to the gameworld state by performing a sequence of inverse editing operations associated with the first set that undo or reverse editing operations performed to the gameworld subsequent to the first time. After the gameworld has been restored to the gameworld state, the gameworld may be displayed and new edits to the gameworld may be tracked from the restored gameworld state.

In one embodiment, an analog undo operation may be performed to place a gameworld into a previous first state associated with a first edit time of the plurality of edit times. After the gameworld has been restored to the first state, an analog redo operation may be performed to place the gameworld into a previous second state associated with a second edit time of the plurality of edit times subsequent to the first edit time. In some cases, performing an analog undo operation followed by an analog redo operation may be viewed as first rewinding a state of the gameworld to the first edit time and then fast forwarding the state of the gameworld to the second edit time. After the gameworld has been restored to the second state, new edits to the gameworld may be tracked.

In another embodiment, an edit tracking pause mode may be entered in which new edits performed to a restored gameworld state may be separately buffered and then an analog redo operation may be performed after the new edits have been performed, wherein the analog redo operation re-performs a previous set of editing operations that were previously performed to the gameworld. In one example, an analog undo operation may be performed to place a gameworld into a previous first state associated with a first edit time of the plurality of edit times. After the gameworld has been restored to the first state, new edits may be made to the gameworld placing the gameworld into a second gameworld state. The new edits may be tracked and associated with a plurality of paused edit times different from the plurality of edit times. Thereafter, an analog redo operation may be performed to place the gameworld into a third state from the second state by performing a previous set of editing operations that were previously performed to the gameworld. In some cases, the analog redo operation may be performed only if the previous set of editing operations do not conflict with the new edits made to the gameworld. In other cases, the analog redo operation may be performed only if the new edits made to the gameworld during the edit tracking pause mode are independent from the previous set of editing operations (e.g., the new edits made to the gameworld comprise edits to a first object within a gameworld and the previous set of editing operations comprise edits to a second object within the gameworld). After the gameworld has been placed into the third state, additional edits to the gameworld may be tracked.

In some embodiments, one or more editing operations that were performed to a gameworld may be saved as a snippet for later reuse. In one example, a game developer may identify a snippet by selecting a portion of an editing operations timeline (or an analog undo bar), such as the editing operations timeline associated with analog rewind slider 608 in FIG. 6A. In another example, a game developer may enter a snippet recording mode in which a sequence of editing operations may be recorded and then saved as a snippet. In some cases, one or more variables associated with the editing operations of a snippet may be modified prior to the snippet being executed. The one or more variables may include a position, a color, or a scale. In one embodiment, a game developer may save a first snippet associated with designing an NPC (e.g., a hostile creature) and a second snippet associated with designing a gameworld structure (e.g., a house or catapult). The game developer may then identify input variables corresponding with the first snippet including a first variable associated with a position of the NPC within a gameworld, a second variable associated with a color of the NPC, and a third variable associated with the scale or size of the NPC. The game developer may then execute the first snippet using a first set of input variables in order to create a first NPC within the gameworld and then execute the first snippet again using a second set of input variables in order to create a second NPC within the gameworld.

In step 644, an analog redo operation corresponding with a second time of the plurality of edit times subsequent to the first time is detected. In one embodiment, the analog redo operation may be detected when an analog rewind slider, such as analog rewind slider 608 in FIG. 6A, is moved to correspond with an edit previously made to the gameworld that was performed subsequent to the first time. For example, an end user of a computer graphics editing tool may use their finger to drag the analog rewind slider using a touchscreen display, such as touchscreen display 256 in FIG. 2, along an editing operations timeline associated with editing operations previously performed on the gameworld.

In step 646, a second gameworld state of the gameworld is determined based on the restored gameworld state and the first set of the plurality of edits. The second gameworld state may be determined by performing editing operations performed to the gameworld subsequent to the first time. In step 648, the gameworld corresponding with the second gameworld state is displayed. In one embodiment, the gameworld corresponding with the second gameworld state may be displayed based on a camera position and a camera orientation previously used at the second time. The gameworld may be displayed using a display, such as display 124 and FIG. 1.

One embodiment of the disclosed technology includes acquiring a plurality of edits associated with editing a virtual world. The plurality of edits corresponds with a plurality of edit times. The method further comprises acquiring additional editing information associated with the plurality of edits. The additional editing information includes a camera position and a camera orientation associated with a first time of the plurality of edit times. The method further comprises detecting an analog undo operation corresponding with the first time and determining a virtual world state of the virtual world at the first time based on the plurality of edits. The determining a virtual world state includes undoing a first set of edits of the plurality of edits that were applied to the virtual world subsequent to the first time. The method further comprises restoring the virtual world to the virtual world state at the first time and displaying the virtual world corresponding with the virtual world state based on the camera position and the camera orientation.

One embodiment of the disclosed technology includes a memory and one or more processors in communication with the memory. The memory stores a plurality of edits associated with editing a virtual world. The plurality of edits corresponds with a plurality of edit times. The one or more processors acquire additional editing information associated with the plurality of edits. The additional editing information includes a camera position and a camera orientation associated with a first time of the plurality of edit times. The one or more processors detect an analog undo operation corresponding with the first time and determine a virtual world state of the virtual world at the first time based on the plurality of edits. The one or more processors determine the virtual world state by undoing a first set of edits of the plurality of edits that were applied to the virtual world subsequent to the first time. The one or more processors restore the virtual world to the virtual world state at the first time and cause the virtual world corresponding with the virtual world state to be displayed based on the camera position and the camera orientation.

One embodiment of the disclosed technology includes acquiring at a computing system a plurality of edits associated with editing a virtual world. The plurality of edits corresponds with a plurality of edit times. Each edit time of the plurality of edit times is associated with a time stamp. The method further comprises acquiring additional editing information associated with the plurality of edits. The additional editing information includes a camera position and a camera orientation associated with a first time of the plurality of edit times. The method further comprises detecting an analog undo operation corresponding with the first time and determining a virtual world state of the virtual world at the first time based on the plurality of edits. The determining a virtual world state includes reversing a first set of edits of the plurality of edits that were applied to the virtual world subsequent to the first time. The method further comprises restoring the virtual world to the virtual world state at the first time and displaying the virtual world corresponding with the virtual world state based on the camera position and the camera orientation.

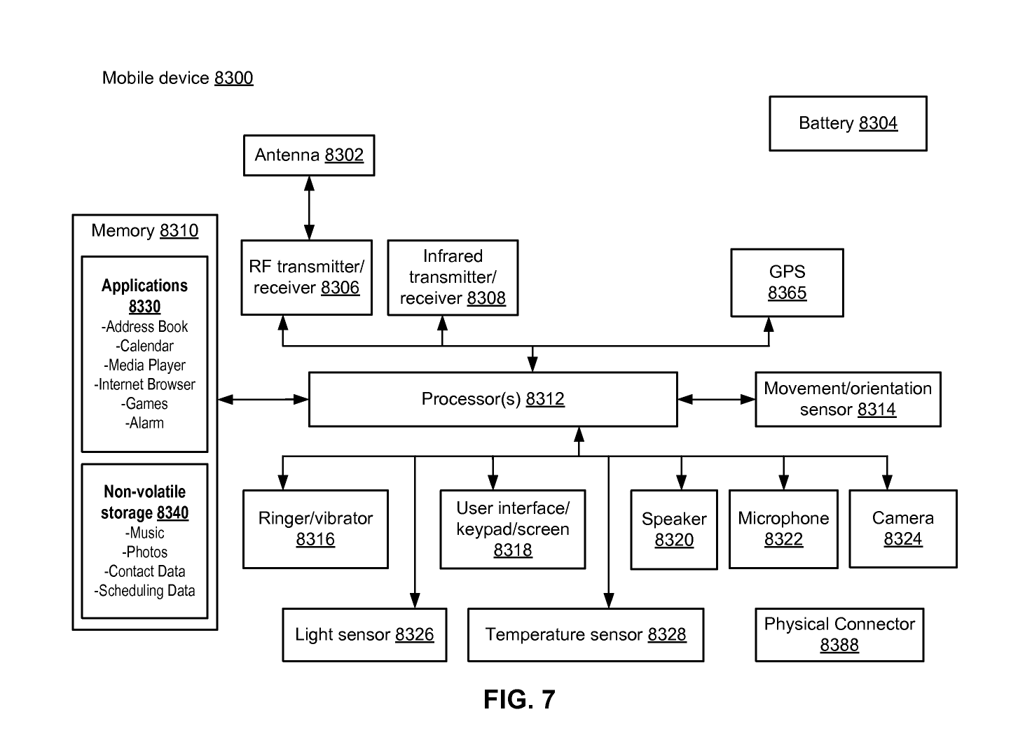

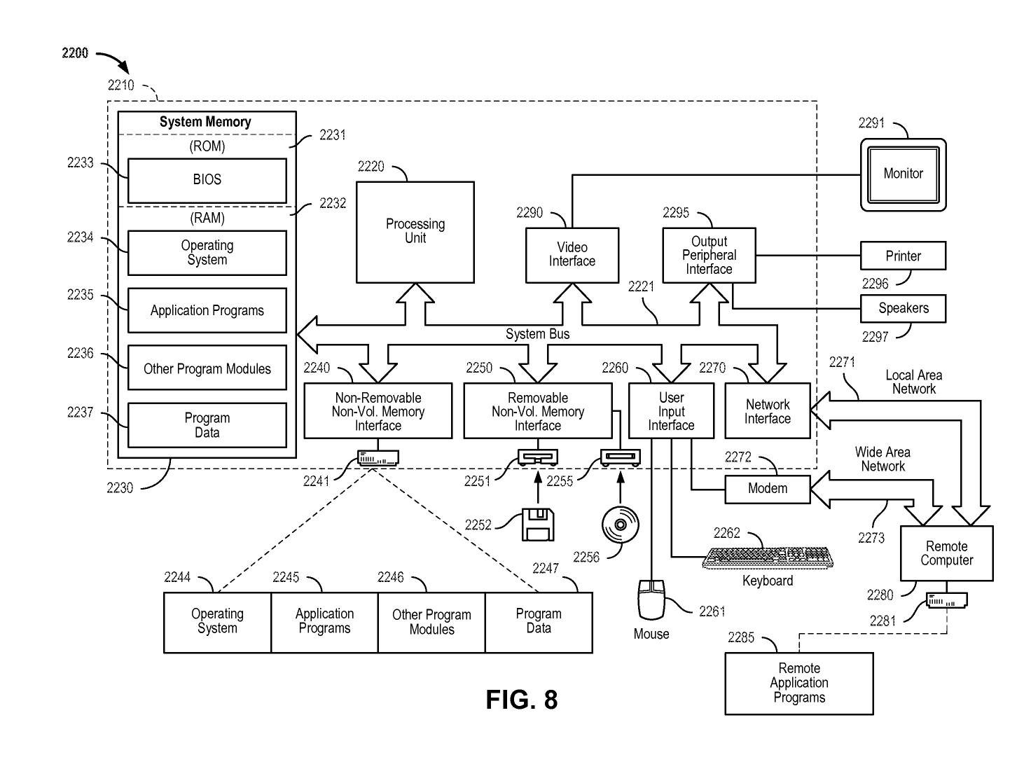

The disclosed technology may be used with various computing systems. FIGS. 7-8 provide examples of various computing systems that can be used to implement embodiments of the disclosed technology.

FIG. 7 is a block diagram of one embodiment of a mobile device 8300, such as mobile device 12 in FIG. 1. Mobile devices may include laptop computers, pocket computers, mobile phones, personal digital assistants, and handheld media devices that have been integrated with wireless receiver/transmitter technology.

Mobile device 8300 includes one or more processors 8312 and memory 8310. Memory 8310 includes applications 8330 and non-volatile storage 8340. Memory 8310 can be any variety of memory storage media types, including non-volatile and volatile memory. A mobile device operating system handles the different operations of the mobile device 8300 and may contain user interfaces for operations, such as placing and receiving phone calls, text messaging, checking voicemail, and the like. The applications 8330 can be any assortment of programs, such as a camera application for photos and/or videos, an address book, a calendar application, a media player, an internet browser, games, an alarm application, and other applications. The non-volatile storage component 8340 in memory 8310 may contain data such as music, photos, contact data, scheduling data, and other files.

The one or more processors 8312 also communicates with RF transmitter/receiver 8306 which in turn is coupled to an antenna 8302, with infrared transmitter/receiver 8308, with global positioning service (GPS) receiver 8365, and with movement/orientation sensor 8314 which may include an accelerometer and/or magnetometer. RF transmitter/receiver 8308 may enable wireless communication via various wireless technology standards such as Bluetooth® or the IEEE 802.11 standards. Accelerometers have been incorporated into mobile devices to enable applications such as intelligent user interface applications that let users input commands through gestures, and orientation applications which can automatically change the display from portrait to landscape when the mobile device is rotated. An accelerometer can be provided, e.g., by a micro-electromechanical system (MEMS) which is a tiny mechanical device (of micrometer dimensions) built onto a semiconductor chip. Acceleration direction, as well as orientation, vibration, and shock can be sensed. The one or more processors 8312 further communicate with a ringer/vibrator 8316, a user interface keypad/screen 8318, a speaker 8320, a microphone 8322, a camera 8324, a light sensor 8326, and a temperature sensor 8328. The user interface keypad/screen may include a touch-sensitive screen display.

The one or more processors 8312 controls transmission and reception of wireless signals. During a transmission mode, the one or more processors 8312 provide voice signals from microphone 8322, or other data signals, to the RF transmitter/receiver 8306. The transmitter/receiver 8306 transmits the signals through the antenna 8302. The ringer/vibrator 8316 is used to signal an incoming call, text message, calendar reminder, alarm clock reminder, or other notification to the user. During a receiving mode, the RF transmitter/receiver 8306 receives a voice signal or data signal from a remote station through the antenna 8302. A received voice signal is provided to the speaker 8320 while other received data signals are processed appropriately.

Additionally, a physical connector 8388 may be used to connect the mobile device 8300 to an external power source, such as an AC adapter or powered docking station, in order to recharge battery 8304. The physical connector 8388 may also be used as a data connection to an external computing device. The data connection allows for operations such as synchronizing mobile device data with the computing data on another device.

FIG. 8 is a block diagram of an embodiment of a computing system environment 2200, such as computing environment 11 in FIG. 1. Computing system environment 2200 includes a general purpose computing device in the form of a computer 2210. Components of computer 2210 may include, but are not limited to, a processing unit 2220, a system memory 2230, and a system bus 2221 that couples various system components including the system memory 2230 to the processing unit 2220. The system bus 2221 may be any of several types of bus structures including a memory bus, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 2210 typically includes a variety of computer readable media. Computer readable media can be any available media that can be accessed by computer 2210 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 2210. Combinations of the any of the above should also be included within the scope of computer readable media.

The system memory 2230 includes computer storage media in the form of volatile and/or nonvolatile memory such as read only memory (ROM) 2231 and random access memory (RAM) 2232. A basic input/output system 2233 (BIOS), containing the basic routines that help to transfer information between elements within computer 2210, such as during start-up, is typically stored in ROM 2231. RAM 2232 typically contains data and/or program modules that are immediately accessible to and/or presently being operated on by processing unit 2220. By way of example, and not limitation, FIG. 8 illustrates operating system 2234, application programs 2235, other program modules 2236, and program data 2237.

The computer 2210 may also include other removable/non-removable, volatile/nonvolatile computer storage media. By way of example only, FIG. 8 illustrates a hard disk drive 2241 that reads from or writes to non-removable, nonvolatile magnetic media, a magnetic disk drive 2251 that reads from or writes to a removable, nonvolatile magnetic disk 2252, and an optical disk drive 2255 that reads from or writes to a removable, nonvolatile optical disk 2256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 2241 is typically connected to the system bus 2221 through an non-removable memory interface such as interface 2240, and magnetic disk drive 2251 and optical disk drive 2255 are typically connected to the system bus 2221 by a removable memory interface, such as interface 2250.

The drives and their associated computer storage media discussed above and illustrated in FIG. 8, provide storage of computer readable instructions, data structures, program modules and other data for the computer 2210. In FIG. 8, for example, hard disk drive 2241 is illustrated as storing operating system 2244, application programs 2245, other program modules 2246, and program data 2247. Note that these components can either be the same as or different from operating system 2234, application programs 2235, other program modules 2236, and program data 2237. Operating system 2244, application programs 2245, other program modules 2246, and program data 2247 are given different numbers here to illustrate that, at a minimum, they are different copies. A user may enter commands and information into computer 2210 through input devices such as a keyboard 2262 and pointing device 2261, commonly referred to as a mouse, trackball, or touch pad. Other input devices (not shown) may include a microphone, joystick, game pad, satellite dish, scanner, or the like. These and other input devices are often connected to the processing unit 2220 through a user input interface 2260 that is coupled to the system bus, but may be connected by other interface and bus structures, such as a parallel port, game port or a universal serial bus (USB). A monitor 2291 or other type of display device is also connected to the system bus 2221 via an interface, such as a video interface 2290. In addition to the monitor, computers may also include other peripheral output devices such as speakers 2297 and printer 2296, which may be connected through an output peripheral interface 2295.

The computer 2210 may operate in a networked environment using logical connections to one or more remote computers, such as a remote computer 2280. The remote computer 2280 may be a personal computer, a server, a router, a network PC, a peer device or other common network node, and typically includes many or all of the elements described above relative to the computer 2210, although only a memory storage device 2281 has been illustrated in FIG. 8. The logical connections depicted in FIG. 8 include a local area network (LAN) 2271 and a wide area network (WAN) 2273, but may also include other networks. Such networking environments are commonplace in offices, enterprise-wide computer networks, intranets and the Internet.

When used in a LAN networking environment, the computer 2210 is connected to the LAN 2271 through a network interface or adapter 2270. When used in a WAN networking environment, the computer 2210 typically includes a modem 2272 or other means for establishing communications over the WAN 2273, such as the Internet. The modem 2272, which may be internal or external, may be connected to the system bus 2221 via the user input interface 2260, or other appropriate mechanism. In a networked environment, program modules depicted relative to the computer 2210, or portions thereof, may be stored in the remote memory storage device. By way of example, and not limitation, FIG. 8 illustrates remote application programs 2285 as residing on memory device 2281. It will be appreciated that the network connections shown are exemplary and other means of establishing a communications link between the computers may be used.

The disclosed technology may be operational with numerous other general purpose or special purpose computing system environments. Examples of other computing system environments that may be suitable for use with the disclosed technology include, but are not limited to, personal computers, server computers, hand-held or laptop devices, multiprocessor systems, microprocessor-based systems, programmable consumer electronics, network PCs, minicomputers, mainframe computers, and distributed computing environments that include any of the above systems or devices, and the like.

The disclosed technology may be described in the general context of computer-executable instructions, such as program modules, being executed by a computer. Generally, software and program modules as described herein include routines, programs, objects, components, data structures, and other types of structures that perform particular tasks or implement particular abstract data types. Hardware or combinations of hardware and software may be substituted for software modules as described herein.

The disclosed technology may also be practiced in distributed computing environments where tasks are performed by remote processing devices that are linked through a communications network. In a distributed computing environment, program modules may be located in both local and remote computer storage media including memory storage devices.

For purposes of this document, each process associated with the disclosed technology may be performed continuously and by one or more computing devices. Each step in a process may be performed by the same or different computing devices as those used in other steps, and each step need not necessarily be performed by a single computing device.

For purposes of this document, reference in the specification to “an embodiment,” “one embodiment,” “some embodiments,” or “another embodiment” may be used to described different embodiments and do not necessarily refer to the same embodiment.

For purposes of this document, a connection can be a direct connection or an indirect connection (e.g., via another part).

For purposes of this document, the term “set” of objects, refers to a “set” of one or more of the objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for generating a virtual world, comprising:
acquiring a plurality of edits associated with editing the virtual world, the plurality of edits corresponds with a plurality of edit times;
acquiring additional editing information associated with the plurality of edits, the additional editing information includes a camera position and a camera orientation associated with a first time of the plurality of edit times;
detecting an analog undo operation corresponding with the first time;
determining a virtual world state of the virtual world at the first time based on the plurality of edits, the determining a virtual world state includes undoing a first set of edits of the plurality of edits that were applied to the virtual world subsequent to the first time;
restoring the virtual world to the virtual world state at the first time; and
displaying the virtual world corresponding with the virtual world state based on the camera position and the camera orientation.

2. The method of claim 1, wherein:
the virtual world comprises a gameworld; and
each edit of the plurality of edits is time stamped based on a time at which the edit was made to the gameworld.

3. The method of claim 1, further comprising:
enabling an editing mode associated with the first time in response to displaying the virtual world, the additional editing information includes the editing mode associated with the first time.

4. The method of claim 3, wherein:
the addition editing information includes an editing tool selection associated with the first time, the enabling an editing mode includes enabling the editing tool selection.

5. The method of claim 1, wherein:
the displaying the virtual world includes displaying the virtual world using a touchscreen display; and
the detecting an analog undo operation includes detecting a finger gesture using the touchscreen display.

6. The method of claim 1, further comprising:
detecting an analog redo operation corresponding with a second time of the plurality of edit times, the detecting an analog redo operation is performed subsequent to the restoring the virtual world to the virtual world state at the first time, the second time is subsequent to the first time;
determining a second virtual world state of the virtual world at the second time based on the plurality of edits; and
displaying the virtual world corresponding with the second virtual world state.

7. The method of claim 1, wherein:
the plurality of edit times corresponds with an edit tracking frequency.

8. The method of claim 7, wherein:
the edit tracking frequency is adjusted based on an editing mode used for making an edit of the plurality of edits.

9. The method of claim 7, wherein:
the edit tracking frequency is adjusted based on an average rate of editing changes associated with a subset of the plurality of edits.

10. A system for generating a virtual world, comprising:
a memory, the memory stores a plurality of edits associated with editing the virtual world, the plurality of edits corresponds with a plurality of edit times; and
one or more processors in communication with the memory, the one or more processors acquire additional editing information associated with the plurality of edits, the additional editing information includes a camera position and a camera orientation associated with a first time of the plurality of edit times, the one or more processors detect an analog undo operation corresponding with the first time, the one or more processors determine a virtual world state of the virtual world at the first time based on the plurality of edits, the one or more processors determine the virtual world state by undoing a first set of edits of the plurality of edits that were applied to the virtual world subsequent to the first time, the one or more processors restore the virtual world to the virtual world state at the first time, the one or more processors cause the virtual world corresponding with the virtual world state to be displayed based on the camera position and the camera orientation.

11. The system of claim 10, wherein:
the virtual world comprises a gameworld; and
each edit of the plurality of edits is time stamped based on a time at which the edit was made to the gameworld.

12. The system of claim 10, wherein:
the one or more processors enable an editing mode associated with the first time in response to causing the virtual world to be displayed, the additional editing information includes the editing mode associated with the first time.

13. The system of claim 12, wherein:
the addition editing information includes an editing tool selection associated with the first time, the one or more processors enable the editing tool selection in response to causing the virtual world to be displayed.

14. The system of claim 10, further comprising:
a touchscreen display, the one or more processors cause the virtual world corresponding with the virtual world state to be displayed on the touchscreen display, the one or more processors detect the analog undo operation corresponding with the first time by detecting a finger gesture using the touchscreen display.

15. The system of claim 10, wherein:
the plurality of edit times corresponds with an edit tracking frequency.

16. The system of claim 15, wherein:
the edit tracking frequency is adjusted based on an editing mode used for making an edit of the plurality of edits.

17. The system of claim 15, wherein:
the edit tracking frequency is adjusted based on an average rate of editing changes associated with a subset of the plurality of edits.

18. One or more storage devices containing processor readable code for programming one or more processors to perform a method for generating a virtual world using a computing system comprising the steps of:
acquiring at the computing system a plurality of edits associated with editing the virtual world, the plurality of edits corresponds with a plurality of edit times, each edit time of the plurality of edit times is associated with a time stamp;
acquiring additional editing information associated with the plurality of edits, the additional editing information includes a camera position and a camera orientation associated with a first time of the plurality of edit times;
detecting an analog undo operation corresponding with the first time;
determining a virtual world state of the virtual world at the first time based on the plurality of edits, the determining a virtual world state includes reversing a first set of edits of the plurality of edits that were applied to the virtual world subsequent to the first time;
restoring the virtual world to the virtual world state at the first time, the restoring the virtual world is performed by the computing system; and
displaying the virtual world corresponding with the virtual world state based on the camera position and the camera orientation.

19. The one or more storage devices of claim 18, wherein:
the virtual world comprises a gameworld;
the displaying the virtual world includes displaying the virtual world using a touchscreen display; and
the detecting an analog undo operation includes detecting a finger gesture using the touchscreen display.

20. The one or more storage devices of claim 18, wherein:
the plurality of edit times corresponds with an edit tracking frequency, the edit tracking frequency is adjusted based on an editing mode used for making an edit of the plurality of edits.
